(19) United States
(12) Patent Application Publication
(10) Pub. No.: US 2025/0271632 A1
(43) Pub. Date: Aug. 28, 2025

(54) OPTICAL SYSTEM AND IMAGE PICKUP APPARATUS

(71) Applicant: CANON KABUSHIKI KAISHA, Tokyo (JP)

(72) Inventors: Tomohiro INO, Tochigi (JP); Takashi ODE, Tochigi (JP); Yuki MATSUBA, Tochigi (JP)

(21) Appl. No.: 19/042,030

(22) Filed: Jan. 31, 2025

(30) Foreign Application Priority Data
Feb. 27, 2024 (JP) 2024-027205

(51) Int. Cl. G02B 7/10; G02B 7/02; G02B 7/09; G02B 13/00

(52) U.S. Cl. CPC G02B 7/10; G02B 7/025; G02B 7/09; G02B 13/0045; G02B 13/006

(57) ABSTRACT

An optical system includes, in order from an object side to an image side, a first lens unit with positive refractive power, a second lens unit with positive refractive power, a third lens unit, a fourth lens unit with positive refractive power; and a fifth lens unit. A distance between adjacent lens units changes during focusing. The optical system further comprises an aperture stop disposed between the second lens unit and the third lens unit or between the third lens unit and the fourth lens unit. For focusing, each of the first lens unit, the third lens unit, and the fifth lens unit does not move, and each of the second lens unit and the fourth lens unit moves. Predetermined inequalities are satisfied.

### BACKGROUND

### Technical Field

The present disclosure relates to an optical system suitable for imaging.

### Description of Related Art

For imaging, an optical system is demanded to have a wide angle of view, a large aperture ratio, a reduced size, high optical performance, and high-speed focusing (especially autofocusing) ability. Japanese Patent Laid-Open Nos. 2019-197125 and 2023-120952 disclose inner focus type optical systems in which a focus lens unit disposed inside the optical system is moved during focusing.

### SUMMARY

An optical system according to one aspect of the disclosure includes, in order from an object side to an image side, a first lens unit with positive refractive power, a second lens unit with positive refractive power, a third lens unit, a fourth lens unit with positive refractive power, and a fifth lens unit. A distance between adjacent lens units changes during focusing. The optical system further includes an aperture stop disposed between the second lens unit and the third lens unit or between the third lens unit and the fourth lens unit. For focusing, each of the first lens unit, the third lens unit, and the fifth lens unit does not move, and each of the second lens unit and the fourth lens unit moves. The following inequalities are satisfied:

$$0.2 \leq f 1 / f \leq 3.6 \\ - 0.05 \leq GFf / GRf \leq 10. \\ 0.2 \leq T 5 / f \leq 0.9$$

where f1 is a focal length of the first lens unit, f is a focal length of the optical system in an in-focus state on an object at infinity, GFf is a combined focal length of all lens units on the object side of the aperture stop in the in-focus state on the object at infinity, GRf is a combined focal length of all lens units on the image side of the aperture stop in the in-focus state on the object at infinity, and T5 is a distance on an optical axis from a lens surface closest to the object of the fifth lens unit to a lens surface closest to an image plane of the fifth lens unit.

An image pickup apparatus having each of the optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a sectional view of an optical system according to Example 1.

FIG. 2A illustrates a longitudinal aberration of the optical system according to Example 1 in an in-focus state at infinity, and FIG. 2B illustrates a longitudinal aberration of the optical system according to Example 1 in an in-focus state at the closest distance.

FIG. 3 illustrates a sectional view of an optical system according to Example 2.

FIG. 4A illustrates a longitudinal aberration of the optical system according to Example 2 in an in-focus state at infinity, and FIG. 4B illustrates a longitudinal aberration of the optical system according to Example 2 in an in-focus state at the closest distance.

FIG. 5 illustrates a sectional view of an optical system according to Example 3.

FIG. 6A illustrates a longitudinal aberration of the optical system according to Example 3 in an in-focus state at infinity, and FIG. 6B illustrates a longitudinal aberration of the optical system according to Example 3 in an in-focus state at the closest distance.

FIG. 7 illustrates a sectional view of an optical system according to Example 4.

FIG. 8A illustrates a longitudinal aberration of the optical system according to Example 4 in an in-focus state at infinity, and FIG. 8B illustrates a longitudinal aberration of the optical system according to Example 4 in an in-focus state at the closest distance.

FIG. 9 illustrates a sectional view of an optical system according to Example 5.

FIG. 10A illustrates a longitudinal aberration of the optical system according to Example 5 in an in-focus state at infinity, and FIG. 10B illustrates a longitudinal aberration of the optical system according to Example 5 in an in-focus state at the closest distance.

FIG. 11 illustrates a sectional view of an optical system according to Example 6.

FIG. 12A illustrates a longitudinal aberration of the optical system according to Example 6 in an in-focus state at infinity, and FIG. 12B illustrates a longitudinal aberration of the optical system according to Example 6 in an in-focus state at the closest distance.

FIG. 13 illustrates a sectional view of an optical system according to Example 7.

FIG. 14A illustrates a longitudinal aberration of the optical system according to Example 7 in an in-focus state at infinity, and FIG. 14B illustrates a longitudinal aberration of the optical system according to Example 7 in an in-focus state at the closest distance.

FIG. 15 illustrates an image pickup apparatus having any one of the optical systems according to Examples 1 to 7.

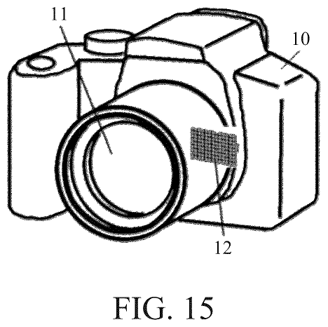

### DETAILED DESCRIPTION

Referring now to the accompanying drawings, a description will be given of embodiments according to the disclosure.

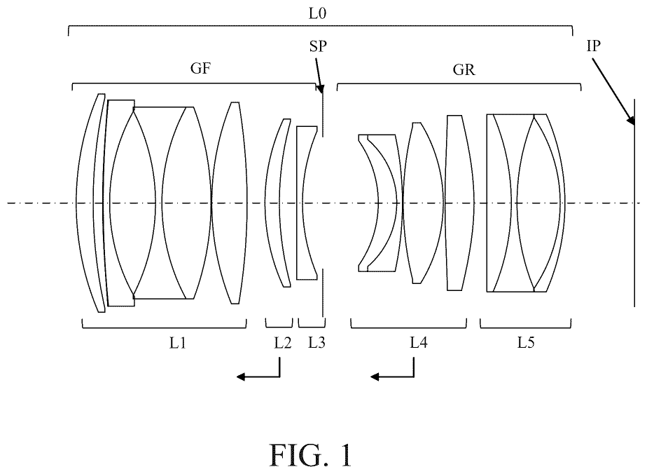

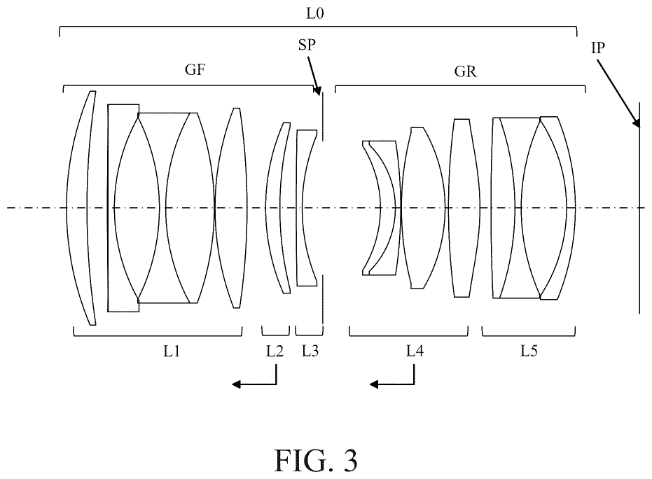

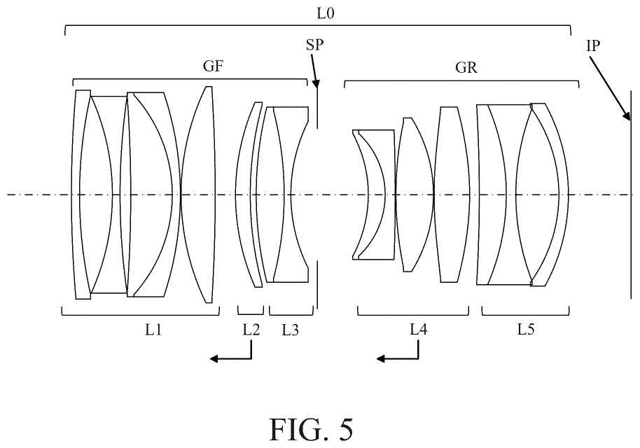

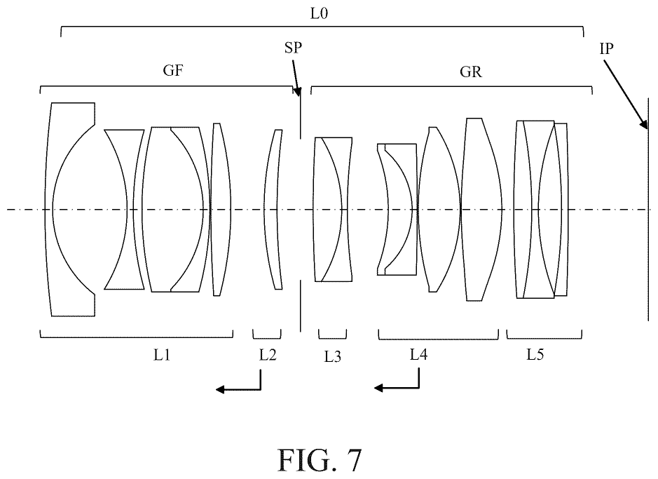

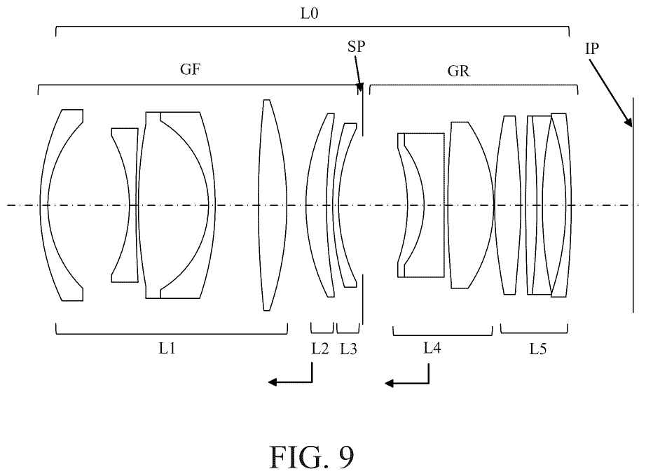

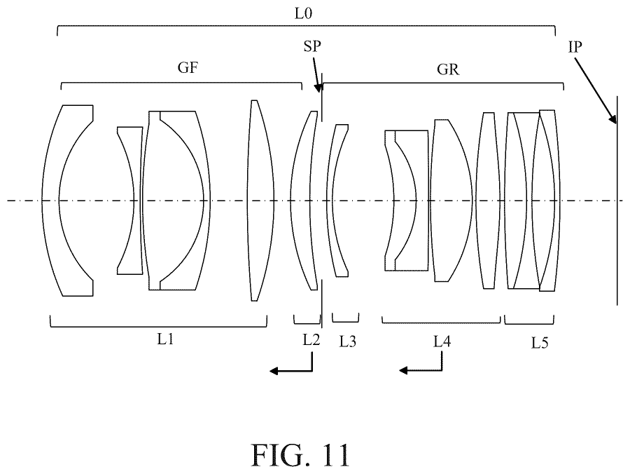

FIGS. 1, 3, 5, 7, 9, 11, and 13 illustrate sections of optical systems according to Examples 1 to 7 in a state where these optical systems are in focus on an object at infinity (hereinafter referred to as “in an in-focus state at infinity”), respectively. In each figure, a left side is an object side (front side) and a right side is an image side (rear side).

The optical system L0 according to each example is used as an imaging optical system for various image pickup apparatuses such as video cameras, digital still cameras, broadcasting cameras, film-based cameras, and surveillance cameras. The imaging optical system may be interchangeable with the image pickup apparatus, or may be integrated with the image pickup apparatus.

The optical system L0 according to each example includes, in order from the object side to the image side, a first lens unit L1 with positive refractive power, a second lens unit L2 with positive refractive power, a third lens unit L3 with positive or negative refractive power, a fourth lens unit L4 with positive refractive power, and a fifth lens unit L5 with positive or negative refractive power. A lens unit is a group of one or more lenses that integrally moves or does not move during focusing. That is, a distance between adjacent lens units changes during focusing. The lens unit may include an aperture stop (diaphragm).

In each figure, SP represents an aperture stop, and IP represents an image plane. In the optical system L0 according to each example, the aperture stop SP is disposed between the second lens unit L2 and the third lens unit L3, or between the third lens unit L3 and the fourth lens unit L4. An imaging surface (light receiving surface) of a solid-state image sensor such as a CCD sensor or a CMOS sensor, or a film surface (photosensitive surface) of a silver film is disposed on the image plane IP.

In the optical system L0 according to each example, the first lens unit L1, the third lens unit L3, and the fifth lens unit L5 do not move relative to the image plane IP during focusing, and only the second lens unit L2 and the fourth lens unit L4, which serve as focus lens units, move. An arrow under each lens unit in each figure indicates a moving direction of each focus lens unit during focusing from infinity to a close distance.

In order to achieve high-speed autofocus (AF) in an optical system having a reduced size, high optical performance, a wide angle of view, and a large aperture ratio, it is important to properly arrange the lens units that constitute the optical system and properly set the configuration and arrangement of the focus lens unit. In the optical system L0 according to each example, aberration correction and weight reduction of the focus lens unit are achieved by moving a part of the focus lens units (L1 to L5) that constitute the optical system. In addition, by distributing power to two focus lens units, aberrational fluctuations during focusing, especially astigmatism, coma, and lateral chromatic aberration, can be easily suppressed.

In the optical system L0 according to each example, each of the second lens unit L2 and the fourth lens unit L4 moves toward the object side during focusing from infinity to a close distance.

A specific description will now be given of the configuration of the optical system L0 according to each example. The optical systems L0 according to Examples 1, 2, 3 and 5 include a first lens unit L1 with positive refractive power, a second lens unit L2 with positive refractive power, a third lens unit L3 with negative refractive power, an aperture stop SP, a fourth lens unit L4 with positive refractive power, and a fifth lens unit L5 with negative refractive power.

The optical system L0 according to Example 4 includes a first lens unit L1 with positive refractive power, a second lens unit L2 with positive refractive power, an aperture stop SP, a third lens unit L3 with positive refractive power, a fourth lens unit L4 with positive refractive power, and a fifth lens unit L5 with negative refractive power.

The optical system L0 according to Example 6 includes a first lens unit L1 with positive refractive power, a second lens unit L2 with positive refractive power, an aperture stop SP, a third lens unit L3 with negative refractive power, a fourth lens unit L4 with positive refractive power, and a fifth lens unit L5 with negative refractive power.

The optical system L0 according to Example 7 includes a first lens unit L1 with positive refractive power, a second lens unit L2 with positive refractive power, a third lens unit L3 with negative refractive power, an aperture stop SP, a fourth lens unit L4 with positive refractive power, and a fifth lens unit L5 with positive refractive power.

In each embodiment, the aperture stop SP is disposed near the center of the entire optical system L0, improving the symmetry before and after the aperture stop SP in the optical system L0 and making it easier to correct coma and distortion.

The optical system L0 according to each example having the above configuration may satisfy the following inequalities (1) and (2):

$$0.2 \leq f 1 / f \leq 3.6 \qquad ( 1 )$$

$$- 0.05 \leq GFf / GRf \leq 10. \qquad ( 2 )$$

In inequalities (1) and (2), f is a focal length of the optical system L0 in an in-focus state at infinity, f1 is a focal length of the first lens unit L1, GFf is a combined focal length of all lens units on the image side of the aperture stop SP in optical system L0 in an in-focus state at infinity, and GRf is a combined focal length of all lens units on the object side of the aperture stop SP in optical system L0 in an in-focus state at infinity. The lens units on the image side of the aperture stop SP include the fourth and fifth lens units L4 and L5 in Examples 1, 2, 3, 5, and 7, and the third to fifth lens units L3 to L5 in Examples 4 and 6. The lens units on the object side of the aperture stop SP include the first and third lens units L1 to L3 in Examples 1, 2, 3, 5, and 7, and the first and second lens units L1 and L2 in Examples 4 and 6.

Inequality (1) defines a proper relationship between the focal length of the first lens unit L1 and the focal length of the optical system L0. In a case where f1/f becomes lower than the lower limit of inequality (1), the focal length of the first lens unit L1 reduces, i.e., the refractive power of the first lens unit L1 increases, and it becomes difficult to correct astigmatism and spherical aberration. In a case where f1/f becomes higher than the upper limit of inequality (1), the focal length of the first lens unit L1 increases, i.e., the refractive power of the first lens unit L1 reduces, the light beam entering the optical system L0 cannot be sufficiently converged, and the light beam diameter entering the second lens unit L2 and the aperture stop SP increases. As a result, the diameter and weight of the second lens unit L2 increase, and it becomes difficult to drive the second lens unit L2 at a high speed during AF. In addition, as the diameter of the aperture stop SP increases, the size of the optical system L0 increases, and the weight of the optical system L0 increases.

Inequality (2) defines a proper relationship between the combined focal length of the lens units on the image side of the aperture stop SP and the combined focal length of the lens units on the object side of the aperture stop SP. In a case where GFf/GRf becomes lower than the lower limit of inequality (2), it becomes difficult for the lens units on the image side of the aperture stop SP to correct astigmatism, distortion, and lateral chromatic aberration that occur in the lens units on the object side of the aperture stop SP. In a case where GFf/GRf becomes higher than the upper limit of inequality (2), the combined focal length of the lens unit on the image side of the aperture stop SP increases, that is, the positive refractive power of the lens units on the image side of the aperture stop SP reduces, and the diameter of the light beam entering the aperture stop SP increases. As a result, the diameter of the aperture stop SP increases, and the diameter of the optical system L0 increases.

Inequalities (1) and (2) may be replaced with inequalities (1a) and (2a) below:

$$0.5 \leq f 1 / f \leq 3.5 \qquad ( 1 a )$$

$$- 0.05 \leq GFf / GRf \leq 5. \qquad ( 2 a )$$

Inequalities (1) and (2) may be replaced with inequalities (1b) and (2b) below:

$$0.8 \leq f 1 / f \leq 2. \qquad ( 1 b )$$

$$- 0.05 \leq GFf / GRf \leq 3. \qquad ( 2 b )$$

Satisfying the above configuration and conditions can provide the optical system L0 with a reduced size, a wide angle of view, a large aperture ratio, and high-speed focusing ability, and well-corrected aberrations.

A description will be given of the configuration that may be satisfied by the optical system L0 according to each example.

In the optical system L0 according to each example, the first lens unit L1 may include two negative lenses. Two negative lenses can satisfactorily correct spherical aberrations that would otherwise occur within the first lens unit L1.

In the optical system L0 according to each example, the second lens unit L2 may include a single positive lens element, specifically a single lens having positive refractive power or a single cemented lens in which a plurality of lenses are cemented together, which has positive refractive power as a whole. The second lens unit L2 configured to move during focusing and including a single lens element can easily increase the AF speed.

In the optical system L0 according to each example, the third lens unit L3 may include a single lens element, specifically a single lens or a cemented lens in which a plurality of lenses are cemented together. The third lens unit L3 including a single lens element can reduce the weight of the third lens unit L3, and a secured moving amount of the fourth lens unit during focusing can reduce a close distance at which imaging can be performed.

In the optical system L0 according to each example, the fourth lens unit L4 may include two positive lenses and one negative lens. This configuration can easily suppress aberrational fluctuations during focusing, particularly fluctuations in longitudinal chromatic aberration and spherical aberration. The cemented lenses are counted by the number of lenses that are cemented together (for example, in a case where two lenses are cemented together, the cemented lens is considered to include two lenses).

In the optical system L0 according to each example, the fourth lens unit L4 may include, in order from the object side to the image side, a cemented lens, a biconvex positive lens, and a positive lens. The cemented lens disposed on the object side, where a lens diameter can be kept small, can easily correct longitudinal chromatic aberration while an increase in the weight of the fourth lens unit L4 as a focus lens unit can be suppressed.

In the optical system L0 according to each example, the fourth lens unit L4 may include two positive lenses and the positive lens on the object side may be a biconvex lens. This configuration can easily correct aberrations by dispersing the positive power, and facilitate an increase of the AF speed by suppressing a moving amount of the fourth lens unit L4 as a focus lens unit during AF. In a case where the number of lenses that constitute the fourth lens unit L4 increases, it becomes difficult to reduce the weight of the focus lens unit, so the above configuration is suitable.

In the optical system L0 according to each example, the third lens unit L3, which does not move during focusing, can easily correct longitudinal chromatic aberration and spherical aberration while suppressing an increase in weight of the focus lens unit.

In the optical system L0 according to each example, the fifth lens unit L5 may include one positive lens and two negative lenses. Since the fifth lens unit L5 is a lens unit closest to the image plane IP in the optical system L0, properly setting its configuration is effective in correcting the Petzval sum. Thus, the fifth lens unit L5 including one positive lens and two negative lenses can easily correct curvature of field.

In the optical systems L0 according to Examples 1, 2, 5, and 6, the first lens unit L1 may have an aspheric surface. Providing an aspheric surface to the first lens unit L1, where an off-axis ray is located at a high position, can satisfactorily correct curvature of field, astigmatism, and distortion.

In the optical system L0 according to each example, the second lens unit L2 and the fourth lens unit L4 may move by different moving amounts during focusing. This configuration can easily correct aberrations in an in-focus state on an object at a close distance (referred to as “in an in-focus state at the closest distance” hereinafter).

A description will now be given of conditions that may be satisfied by the optical system L0 according to each example. The optical system L0 according to each example may satisfy at least one of the following inequalities (3) to (15):

$$0.1 \leq SK / f \leq 0.7 \qquad ( 3 )$$

$$0.2 \leq T 1 / f \leq 3. \qquad ( 4 )$$

$$0.01 \leq T 2 / f \leq 0.3 \qquad ( 5 )$$

$$0.01 \leq T 3 / f \leq 0.5 \qquad ( 6 )$$

$$0.1 \leq T 4 / f \leq 1.5 \qquad ( 7 )$$

$$0.2 \leq T 5 / f \leq 0.9 \qquad ( 8 )$$

$$0.5 \leq f 2 / f \leq 9. \qquad ( 9 )$$

$$0.1 \leq f 4 / f \leq 4. \qquad ( 10 )$$

$$0.2 \leq \vert f 5 / f \vert \leq 7. \qquad ( 11 )$$

$$0.5 \leq f 2 / f 4 \leq 7.5 \qquad ( 12 )$$

$$0.1 \leq f 1 / f 2 \leq 5. \qquad ( 13 )$$

$$0.1 \leq f 12 / f \leq 5. \qquad ( 14 )$$

$$0.1 \leq GFf / f \leq 5. \qquad ( 15 )$$

In inequalities (3) to (15), SK is an air equivalent distance on the optical axis from an image-side lens surface of a lens with power that is disposed closest to the image plane among the lenses that constitute the optical system L0 to the image plane (paraxial image plane), and is also called the back focus. T1 is a distance on the optical axis from a lens surface closest to the object of the first lens unit L1 to a lens surface closest to the image plane of the first lens unit L1. T2 is a distance on the optical axis from a lens surface closest to the object of the second lens unit L2 to a lens surface closest to the image plane of the second lens unit L2. T4 is a distance on the optical axis from a lens surface closest to the object of the fourth lens unit L4 to a lens surface closest to the image plane of the fourth lens unit L4. T5 is a distance on the optical axis from a lens surface closest to the object of the fifth lens unit L5 to a lens surface closest to the image plane of the fifth lens unit L5.

f2 is a focal length of the second lens unit L2, f3 is a focal length of the third lens unit L3, f4 is a focal length of the fourth lens unit L4, and f5 is a focal length of the fifth lens unit L5. f12 is a combined focal length of the first lens unit L1 and the second lens unit L2 in an in-focus state at infinity.

Inequality (3) defines a proper relationship between the back focus and the focal length of the optical system L0. In a case where the back focus increases so that SK/f becomes higher than the upper limit of inequality (3), the size of the optical system L0 increases. In a case where the back focus reduces so that SK/f becomes lower than the lower limit of inequality (3), it becomes difficult to place an optical block such as an image sensor and a low-pass filter near the image plane IP.

Inequality (4) defines a proper relationship between the thickness of the first lens unit L1 in the optical axis direction and the focal length of the optical system L0. In a case where the thickness of the first lens unit L1 increases so that T1/f becomes higher than the upper limit of inequality (4), the size of the optical system L0 increases. In a case where the thickness of the first lens unit L1 reduces so that T1/f becomes lower than the lower limit of inequality (4), it becomes difficult to correct aberrations generated in the first lens unit L1, particularly distortion.

Inequality (5) defines a proper relationship between the thickness of the second lens unit L2 in the optical axis direction and the focal length of the optical system L0. In a case where the thickness of the second lens unit L2 increases so that T2/f becomes higher than the upper limit of inequality (5), the size of the optical system L0 increases. In a case where the thickness of the second lens unit L2 reduces so that T2/f becomes lower than the lower limit of inequality (5), it becomes difficult to correct aberrations, particularly distortion, which would otherwise occur in the second lens unit L2.

Inequality (6) defines a proper relationship between the thickness of the third lens unit L3 in the optical axis direction and the focal length of the optical system L0. In a case where the thickness of the third lens unit L3 increases so that T3/f becomes higher than the upper limit of inequality (6), the size of the optical system L0 increases. In a case where the thickness of the third lens unit L3 reduces so that T3/f becomes lower than the lower limit of inequality (6), it becomes difficult to correct aberrations, particularly distortion, which would otherwise occur in the third lens unit L3.

Inequality (7) defines a proper relationship between the thickness of the fourth lens unit L4 in the optical axis direction and the focal length of the optical system L0. In a case where the thickness of the fourth lens unit L4 increases so that T4/f becomes higher than the upper limit of inequality (7), the weight of the fourth lens unit L4 increases, and it becomes difficult to increase the AF speed. In a case where the thickness of the fourth lens unit L4 reduces so that T4/f becomes lower than the lower limit of inequality (7), it becomes difficult to correct aberrations generated in the fourth lens unit L4, particularly spherical aberration and astigmatism.

Inequality (8) defines a proper relationship between the thickness of the fifth lens unit L5 in the optical axis direction and the focal length of the optical system L0. In a case where the thickness of the fifth lens unit L5 increases so that T5/f becomes higher than the upper limit of inequality (8), the size of the optical system L0 increases. In a case where the thickness of the fifth lens unit L5 reduces so that T5/f becomes lower than the lower limit of inequality (8), it becomes difficult to correct curvature of field and distortion.

Inequality (9) defines a proper relationship between the focal length of the second lens unit L2 and the focal length of the optical system L0. In a case where the focal length of the second lens unit L2 reduces so that f2/f becomes lower than the lower limit of inequality (9), the weight of the second lens unit L2 increases, and it becomes difficult to increase the AF speed. In a case where the focal length of the second lens unit L2 increases so that f2/f becomes higher than the upper limit of inequality (9), it becomes difficult to correct aberrational fluctuations, especially astigmatism, during focusing.

Inequality (10) defines a proper relationship between the focal length of the fourth lens unit L4 and the focal length of the optical system L0. In a case where the focal length of the fourth lens unit L4 reduces so that f4/f becomes lower than the lower limit of inequality (10), the weight of the second lens unit L2, which moves together with the fourth lens unit L4 during focusing, increases, and it becomes difficult to increase the AF speed. In a case where the focal length of the fourth lens unit L4 increases so that f4/f becomes higher than the upper limit of inequality (10), it becomes difficult to correct aberrations fluctuations during focusing, particularly spherical aberration and longitudinal chromatic aberration.

Inequality (11) defines a proper relationship between the focal length of the fifth lens unit L5 and the focal length of the optical system L0. In a case where the absolute value of the focal length of the fifth lens unit L5 reduces so that |f5/f| becomes lower than the lower limit of inequality (11), it becomes difficult to correct the Petzval sum and suppress curvature of field. In a case where the absolute value of the focal length of the fifth lens unit L5 increases so that |f5/f| becomes higher than the upper limit of inequality (11), it becomes difficult to secure the back focus.

Inequality (12) defines a proper relationship between the focal lengths of the second lens unit L2 and the fourth lens unit L4. In a case where the focal length of the second lens unit L2 reduces, i.e., the refractive power of the second lens unit L2 increases so that f2/f4 becomes lower than the lower limit of inequality (12), it becomes difficult to correct the curvature of field generated in the second lens unit L2. In a case where the focal length of the fourth lens unit L4 reduces, i.e., the refractive power of the fourth lens unit L4 increases so that f2/f4 becomes higher than the upper limit of inequality (12), it becomes difficult to correct spherical aberration and astigmatism generated in the fourth lens unit L4.

Inequality (13) defines a proper relationship between the focal lengths of the first lens unit L1 and the second lens unit L2. In a case where the focal length of the second lens unit L2 reduces, i.e., the refractive power of the second lens unit L2 increases so that f1/f2 becomes higher than the upper limit of inequality (13), it becomes difficult to correct the curvature of field generated in the second lens unit L2. In a case where the focal length of the first lens unit L1 reduces, i.e., the refractive power of the first lens unit L1 increases so that f1/f2 becomes lower than the lower limit of inequality (13), it becomes difficult to correct spherical aberration and astigmatism generated in the first lens unit L1.

Inequality (14) defines a proper relationship between the combined focal length of the first lens unit L1 and the second lens unit L2 and the focal length of the optical system L0. In a case where the combined focal length of the first lens unit L1 and the second lens unit L2 reduces, i.e., the refractive power increases so that f12/f becomes lower than the lower limit of inequality (14), it becomes difficult to correct spherical aberration generated in the first lens unit L1 and the second lens unit L2. In a case where the combined focal length of the first and second lens units L1 and L2 increases, i.e., the refractive power reduces so that f12/f becomes higher than the upper limit of inequality (14), the diameter of the light beam incident on the aperture stop SP increases, and the diameter of the optical system L0 increases.

Inequality (15) defines a proper relationship between the combined focal length of the lens units on the image side of the aperture stop in optical system L0 and the focal length of the optical system L0. In a case where the combined focal length of the lens units on the image side of the aperture stop SP reduces, i.e., the refractive power increases so that GFf/f becomes lower than the lower limit of inequality (15), it becomes difficult to correct spherical aberration generated in the lens units on the image side of the aperture stop SP. In a case where the combined focal length of the lens units on the image side of the aperture stop SP increases, i.e., the refractive power reduces so that GFf/f becomes higher than the upper limit of inequality (15), the diameter of the light beam incident on the aperture stop SP increases, and the diameter of the optical system L0 increases.

Inequalities (3) to (15) may be replaced with inequalities (3a) to (15a) below:

$$0.2 \leq SK / f \leq 0.67 \qquad ( 3 a )$$

$$0.4 \leq T 1 / f \leq 2. \qquad ( 4 a )$$

$$0.03 \leq T 2 / f \leq 0.2 \qquad ( 5 a )$$

$$0.02 \leq T 3 / f \leq 0.4 \qquad ( 6 a )$$

$$0.3 \leq T 4 / f \leq 1. \qquad ( 7 a )$$

$$0.23 \leq T 5 / f \leq 0.7 \qquad ( 8 a )$$

$$1. \leq f 2 / f \leq 5. \qquad ( 9 a )$$

$$0.3 \leq f 4 / f \leq 3. \qquad ( 10 a )$$

$$1. \leq \vert f 5 / f \vert \leq 5. \qquad ( 11 a )$$

$$1. \leq f 2 / f 4 \leq 5. \qquad ( 12 a )$$

$$0.2 \leq f 1 / f 2 \leq 3. \qquad ( 13 a )$$

$$0.5 \leq f 12 / f \leq 3. \qquad ( 14 a )$$

$$0.3 \leq GFf / f \leq 3. \qquad ( 15 a )$$

Inequalities (3) to (15) may be replaced with inequalities (3b) to (15b) below:

$$0.25 \leq SK / f \leq 0.64 \qquad ( 3 b )$$

$$0.55 \leq T 1 / f \leq 1.5 \qquad ( 4 b )$$

$$0.05 \leq T 2 / f \leq 0.14 \qquad ( 5 b )$$

$$0.01 \leq T 3 / f \leq 0.3 \qquad ( 6 b )$$

$$0.4 \leq T 4 / f \leq 0.95 \qquad ( 7 b )$$

$$0.25 \leq T 5 / f \leq 0.5 \qquad ( 8 b )$$

$$1.9 \leq f 2 / f \leq 3. \qquad ( 9 b )$$

$$0.6 \leq f 4 / f \leq 1.6 \qquad ( 10 b )$$

$$1.5 \leq \vert f 5 / f \vert \leq 3.2 \qquad ( 11 b )$$

$$1.4 \leq f 2 / f 4 \leq 4. \qquad ( 12 b )$$

$$0.3 \leq f 1 / f 2 \leq 1.2 \qquad ( 13 b )$$

$$0.65 \leq f 12 / f \leq 1. \qquad ( 14 b )$$

$$0.7 \leq GFf / f \leq 2.2 \qquad ( 15 b )$$

A description will now be given of numerical examples 1 to 7 corresponding to Examples 1 to 7. In surface data in each numerical example, the surface number i indicates the order of the surface counted from the object side. r represents a radius of curvature (mm) of an i-th surface counted from the object side, and d represents a lens thickness or air gap (mm) on the optical axis between i-th and (i+1)-th surfaces. nd represents a refractive index for the d-line of an optical material between i-th and (i+1)-th surfaces, and vd represents an Abbe number based on the d-line of the optical material between i-th and (i+1)-th surfaces.

The Abbe number vd based on the d-line is expressed as:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer lines.

The distance d in the surface data and the focal length, F-number, and half angle of view (°) in the various data are all values when the optical system is in an in-focus state at infinity. SK represents the back focus (mm) described above. An overall lens length is a distance on the optical axis from a lens surface closest to the object to a lens surface closest to the image plane of the optical system, plus the back focus.

In the surface data, an asterisk “*” next to the surface number means that the surface has an aspheric shape. The aspheric shape is expressed by the following equation:

$$x = ( {h}^{2} / R ) / [ 1 + √ \{ 1 - ( 1 + k ) {( h / R )}^{2} \} ] + A 4 \times {h}^{4} + A 6 \times {h}^{6} + A 8 \times {h}^{8} + A 10 \times {h}^{10} + A 12 \times {h}^{12}$$

where x is a displacement amount from a surface vertex in the optical axis direction, h is a height from the optical axis in a direction orthogonal to the optical axis, a light traveling direction is positive, R is a paraxial radius of curvature, K is a conic constant, and A4, A6, A8, A10, and A12 are aspheric coefficients. The “e±Z” in the conic constant and aspheric coefficient means×10^{±Z}.

The distance d between the lens units is illustrated in the in-focus state at infinity and in the in-focus state at the closest distance. The object distance in the in-focus state at the closest distance is illustrated in parentheses. The object distance is a distance from the image plane to an object.

Table 1 summarizes values corresponding to inequalities (1) to (15) in numerical examples 1 to 7. Each numerical example satisfies all of inequalities (1) to (15).

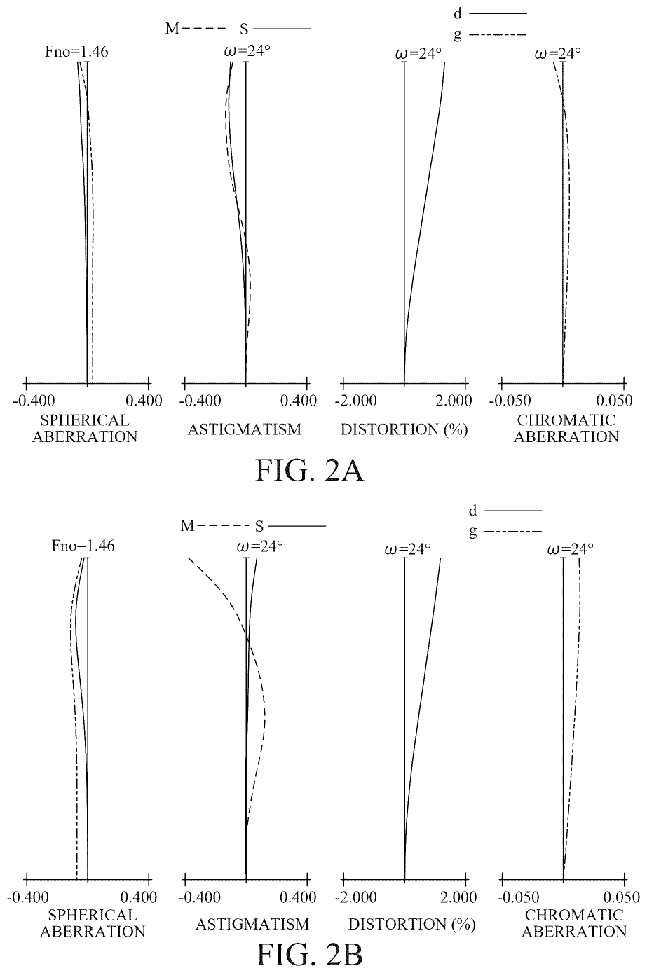

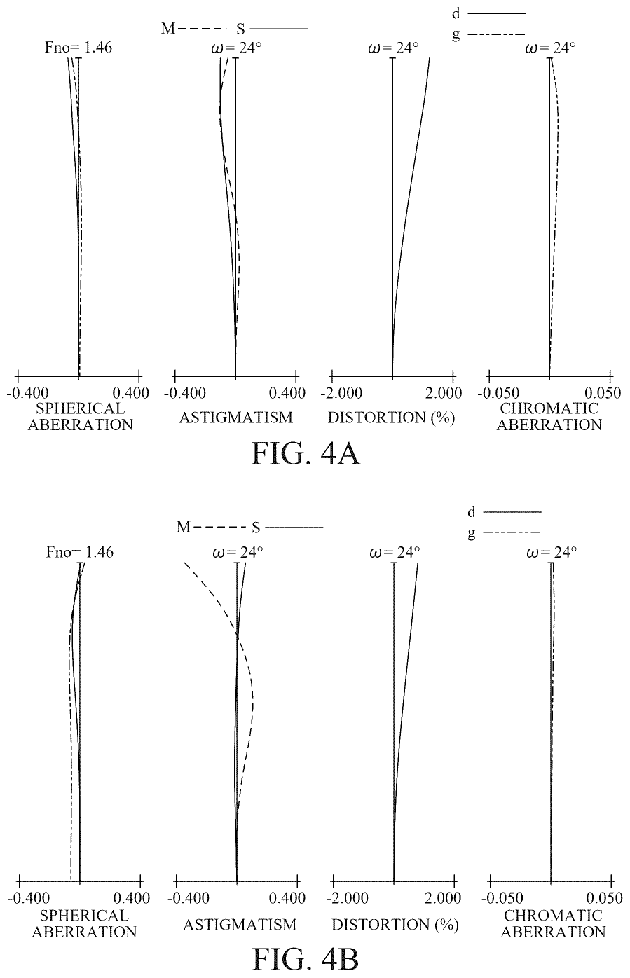

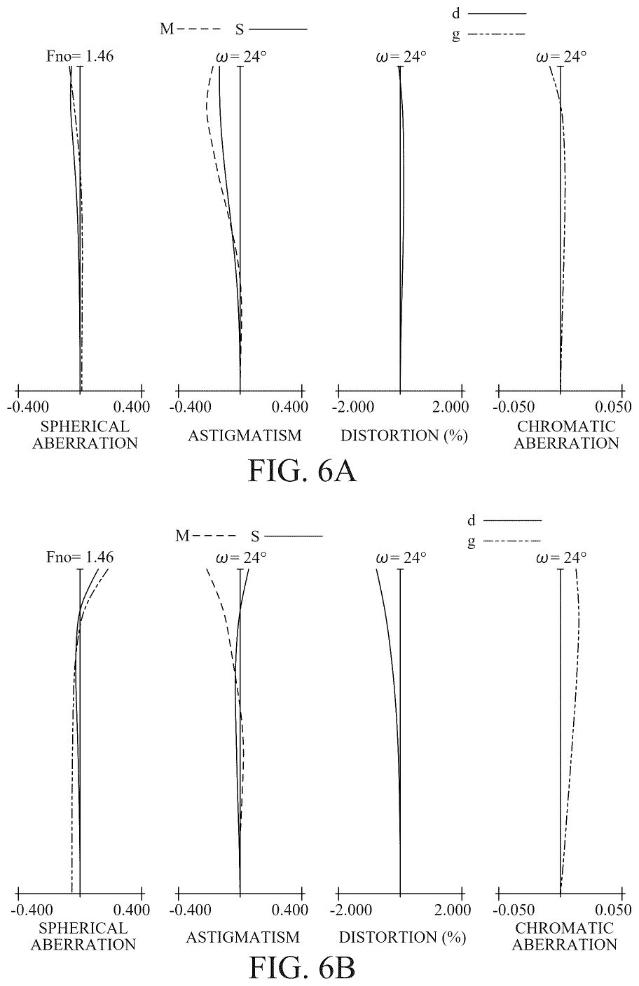

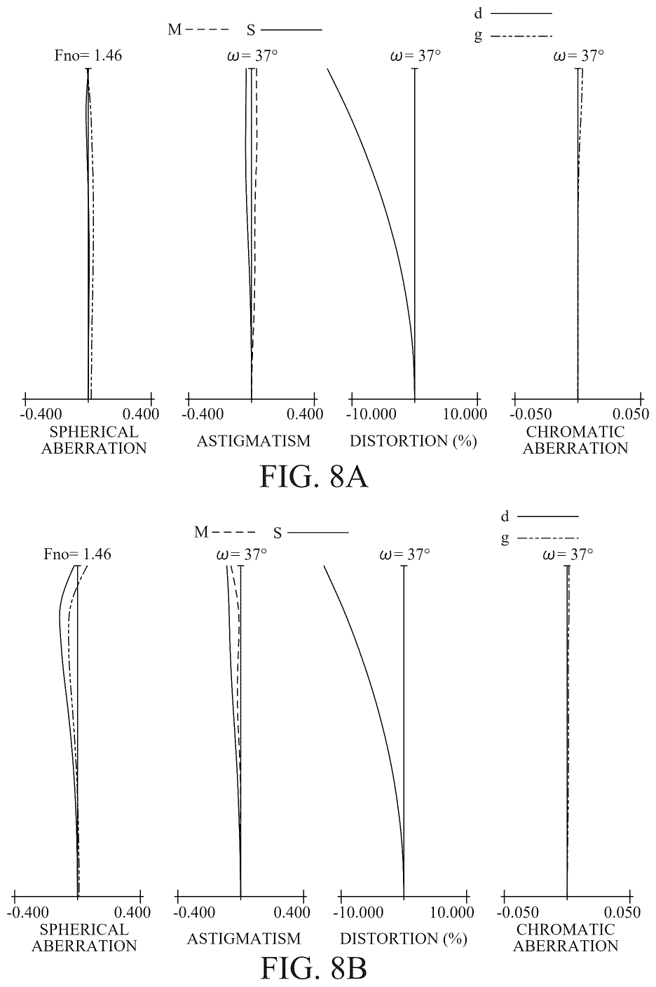

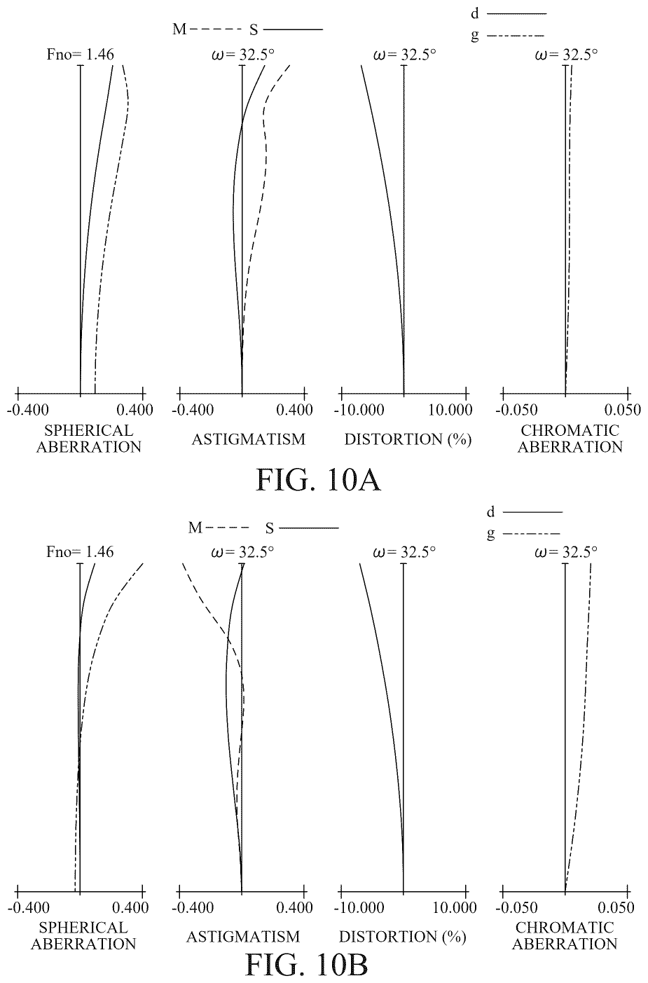

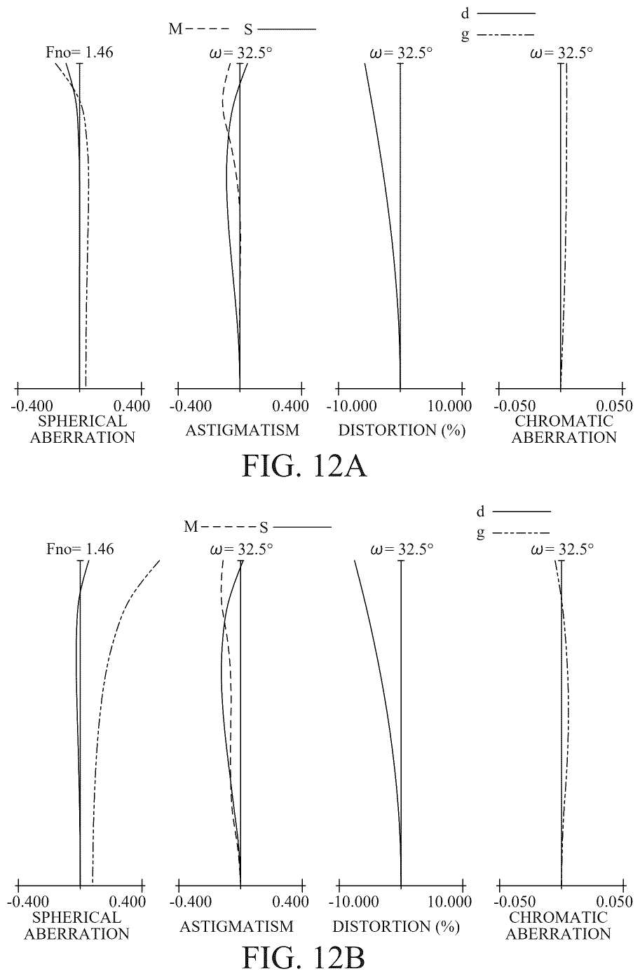

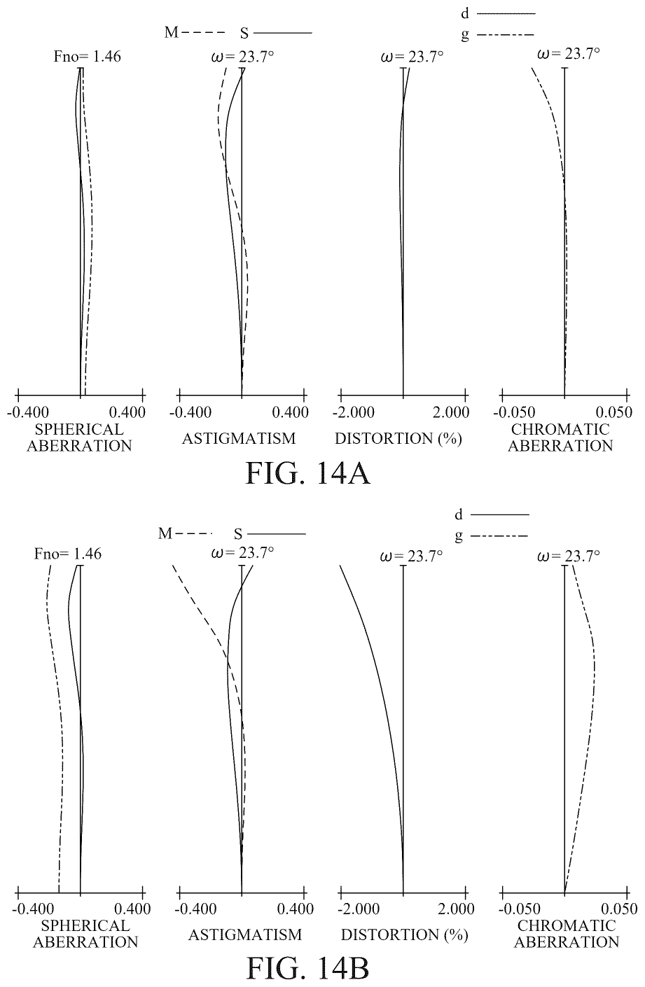

FIGS. 2A, 4A, 6A, 8A, 10A, 12A and 14A respectively illustrate the longitudinal aberration (spherical aberration, astigmatism, distortion, and chromatic aberration) of the optical systems according to numerical examples 1 to 7 in an in-focus states at infinity. FIGS. 2B, 4B, 6B, 8B, 10B, 12B and 14B respectively illustrate the longitudinal aberration (spherical aberration, astigmatism, distortion, and chromatic aberration) of the optical systems according to numerical examples 1 to 7 in an in-focus state at the closest distance.

In the spherical aberration diagram, Fno represents an F-number. A solid line indicates a spherical aberration amount for the d-line, and an alternate long and two short dashes line indicates a spherical aberration amount for the g-line (with a wavelength of 435.8 nm). In the astigmatism diagram, a solid line S indicates an astigmatism amount on a sagittal image plane, and a dashed line M indicates an astigmatism amount on a meridional image plane. A distortion diagram illustrates a distortion amount for the d-line. A chromatic aberration diagram illustrates a lateral chromatic aberration amount for the g-line. ω represents a half angle of view) (°).

NUMERICAL EXAMPLE 1
UNIT: mm
SURFACE DATA

| Surface No. | r | d | nd | νd |
|---|---|---|---|---|
| 1 | 57.769 | 3.57 | 1.92286 | 20.9 |
| 2 | 99.001 | 2.01 | | |
| 3* | 174.690 | 0.11 | 1.53352 | 52.8 |
| 4 | 207.351 | 1.35 | 1.65412 | 39.7 |
| 5 | 39.088 | 9.65 | | |
| 6 | −41.799 | 1.35 | 1.77047 | 29.7 |
| 7 | 41.799 | 10.34 | 1.76385 | 48.5 |
| 8 | −56.227 | 0.15 | | |
| 9 | 55.362 | 7.44 | 1.91082 | 35.2 |
| 10 | −126.226 | (Variable) | | |
| 11 | 41.162 | 3.03 | 1.90043 | 37.4 |
| 12 | 62.716 | (Variable) | | |
| 13 | ∞ | 1.20 | 1.77047 | 29.7 |
| 14 | 38.312 | 4.28 | | |
| 15 | ∞ | (Variable) | | |
| (SP) | | | | |
| 16 | −22.567 | 3.89 | 1.59522 | 67.7 |
| 17 | −17.388 | 1.20 | 1.73037 | 32.2 |
| 18 | −66.069 | 0.16 | | |
| 19 | 65.372 | 8.43 | 1.49700 | 81.7 |
| 20 | −31.807 | 0.37 | | |
| 21* | 195.760 | 6.10 | 1.80400 | 46.5 |
| 22* | −52.537 | (Variable) | | |
| 23 | ∞ | 5.16 | 2.00100 | 29.1 |
| 24 | −46.593 | 1.20 | 1.58144 | 40.8 |
| 25 | 46.593 | 9.09 | | |
| 26 | −31.535 | 1.00 | 1.72825 | 28.5 |
| 27 | −45.428 | 14.66 | | |
| Image Plane | ∞ | | | |

ASPHERIC DATA

3rd Surface
K = 0.00000e+00 A 4 = −3.43375e−07 A 6 = −2.73639e−09
A 8 = 6.57484e−12 A10 = −1.50535e−14 A12 = 9.83500e−18
21st Surface
K = 0.00000e+00 A 4 = −3.27084e−06 A 6 = 6.22450e−10
A 8 = 1.62557e−11 A10 = −9.43111e−14 A12 = 1.12652e−16
22nd Surface
K = 0.00000e+00 A 4 = 6.07848e−06 A 6 = −7.76772e−09
A 8 = 6.38476e−11 A10 = −1.90658e−13 A12 = 1.91577e−16

VARIOUS DATA

| | |
|---|---|
| Zoom Ratio | 1.00 |
| Focal Length | 48.50 |
| Fno | 1.46 |
| Half Angle of View (°) | 24.04 |
| Image Height | 21.64 |
| Overall Lens Length | 117.49 |
| SK | 14.66 |

| | | Closest Distance |
|---|---|---|
| | Infinity | (−400 mm) |
| d10 | 3.76 | 1.46 |
| d12 | 3.66 | 5.98 |
| d15 | 11.67 | 7.27 |
| d22 | 2.68 | 7.08 |

LENS UNIT DATA

| Lens Unit | Starting Surface | Focal Length |
|---|---|---|
| 1 | 1 | 53.02 |
| 2 | 11 | 124.70 |
| 3 | 13 | −49.73 |
| 4 | 16 | 38.05 |
| 5 | 23 | −96.43 |

NUMERICAL EXAMPLE 2
UNIT: mm
SURFACE DATA

| Surface No. | r | d | nd | νd |
|---|---|---|---|---|
| 1 | 61.356 | 4.23 | 2.00069 | 25.5 |
| 2 | 155.534 | 4.23 | | |
| 3* | 836.451 | 0.14 | 1.53352 | 52.8 |
| 4 | 9065.248 | 1.30 | 1.72047 | 34.7 |
| 5 | 37.963 | 9.31 | | |
| 6 | −41.519 | 1.30 | 1.77047 | 29.7 |
| 7 | 40.508 | 10.06 | 1.77250 | 49.6 |
| 8 | −55.412 | 0.15 | | |
| 9 | 56.306 | 6.62 | 1.95375 | 32.3 |
| 10 | −136.914 | (Variable) | | |
| 11 | 43.381 | 2.94 | 1.91082 | 35.2 |
| 12 | 66.751 | (Variable) | | |
| 13 | 730.270 | 1.23 | 1.73037 | 32.2 |
| 14 | 38.613 | 4.26 | | |
| 15 | ∞ | (Variable) | | |
| (SP) | | | | |
| 16 | −23.950 | 3.09 | 1.59522 | 67.7 |
| 17 | −18.367 | 1.10 | 1.77047 | 29.7 |
| 18 | −89.141 | 0.15 | | |
| 19 | 61.370 | 9.03 | 1.49700 | 81.5 |
| 20 | −32.482 | 0.69 | | |
| 21* | 123.050 | 6.50 | 1.80400 | 46.5 |
| 22* | −55.009 | (Variable) | | |
| 23 | 397.215 | 4.95 | 2.00100 | 29.1 |
| 24 | −55.804 | 1.30 | 1.58144 | 40.8 |
| 25 | 42.967 | 9.38 | | |
| 26 | −32.640 | 1.82 | 1.62004 | 36.3 |
| 27 | −48.951 | 13.26 | | |
| Image Plane | ∞ | | | |

ASPHERIC DATA

3rd Surface
K = 0.00000e+00 A 4 = −4.27090e−07 A 6 = −1.54574e−09
A 8 = 3.73197e−12 A10 = −1.06510e−14 A12 = 8.55869e−18
21st Surface
K = 0.00000e+00 A 4 = −3.25844e−06 A 6 = 1.10049e−08
A 8 = −3.65477e−11 A10 = 1.02156e−13 A12 = −9.95585e−17
22nd Surface
K = 0.00000e+00 A 4 = 5.69279e−06 A 6 = 6.86476e−09
A 8 = −1.01569e−11 A10 = 5.22676e−14 A12 = −5.29539e−17

VARIOUS DATA

| | |
|---|---|
| Zoom Ratio | 1.00 |
| Focal Length | 48.50 |
| Fno | 1.46 |
| Half Angle of View (°) | 24.04 |
| Image Height | 21.64 |
| Overall Lens Length | 118.50 |
| SK | 13.26 |

| | | Closest Distance |
|---|---|---|
| | Infinity | (−400 mm) |
| d10 | 3.84 | 1.49 |
| d12 | 3.38 | 5.73 |
| d15 | 11.92 | 7.15 |
| d22 | 2.30 | 7.08 |

LENS UNIT DATA

| Lens Unit | Starting Surface | Focal Length |
|---|---|---|
| 1 | 1 | 55.54 |
| 2 | 11 | 128.35 |
| 3 | 13 | −55.86 |
| 4 | 16 | 39.26 |
| 5 | 23 | −105.72 |

NUMERICAL EXAMPLE 3
UNIT: mm
SURFACE DATA

| Surface No. | r | d | nd | νd |
|---|---|---|---|---|
| 1 | 248.031 | 1.70 | 1.61340 | 44.3 |
| 2 | 93.679 | 6.90 | | |
| 3 | −49.375 | 1.60 | 1.72047 | 34.7 |
| 4 | 141.483 | 2.25 | | |
| 5 | −277.870 | 8.71 | 1.91082 | 35.2 |
| 6 | −30.812 | 1.70 | 1.85478 | 24.8 |
| 7 | −66.429 | 0.15 | | |
| 8 | 51.154 | 7.16 | 1.95375 | 32.3 |
| 9 | −350.929 | (Variable) | | |
| 10 | 47.073 | 3.09 | 1.95375 | 32.3 |
| 11 | 71.654 | (Variable) | | |
| 12 | 75.892 | 5.87 | 1.59522 | 67.7 |
| 13 | −69.471 | 1.40 | 1.73037 | 32.2 |
| 14 | 33.957 | 5.53 | | |
| 15 | ∞ | (Variable) | | |
| (SP) | | | | |
| 16 | −26.609 | 3.54 | 1.59522 | 67.7 |
| 17 | −17.412 | 2.11 | 1.77047 | 29.7 |
| 18 | −373.631 | 0.15 | | |
| 19 | 72.847 | 7.87 | 1.49700 | 81.5 |
| 20 | −30.089 | 0.15 | | |
| 21* | 89.058 | 7.44 | 1.80400 | 46.5 |
| 22* | −57.335 | (Variable) | | |
| 23 | −310.178 | 5.66 | 2.00100 | 29.1 |
| 24 | −46.674 | 2.00 | 1.51633 | 64.1 |
| 25 | 49.131 | 9.03 | | |
| 26 | −30.875 | 2.00 | 1.80810 | 22.8 |
| 27 | −39.182 | 13.15 | | |
| Image Plane | ∞ | | | |

ASPHERIC DATA

21st Surface
K = 0.00000e+00 A 4 = −2.97897e−06 A 6 = −5.12245e−09
A 8 = 2.75799e−11 A10 = −1.25498e−13 A12 = 1.30359e−16
22nd Surface
K = 0.00000e+00 A 4 = 4.90808e−06 A 6 = −8.97778e−09
A 8 = 4.67899e−11 A10 = −1.52794e−13 A12 = 1.43738e−16

VARIOUS DATA

| | |
|---|---|
| Zoom Ratio | 1.00 |
| Focal Length | 48.50 |
| Fno | 1.46 |
| Half Angle of View (°) | 24.04 |
| Image Height | 21.64 |
| Overall Lens Length | 117.40 |
| SK | 13.15 |

| | | Closest Distance |
|---|---|---|
| | Infinity | (−400 mm) |
| d9 | 4.25 | 1.26 |
| d11 | 1.25 | 4.25 |
| d15 | 10.71 | 5.84 |
| d22 | 2.03 | 6.90 |

LENS UNIT DATA

| Lens Unit | Starting Surface | Focal Length |
|---|---|---|
| 1 | 1 | 59.05 |
| 2 | 10 | 135.54 |
| 3 | 12 | −67.42 |
| 4 | 16 | 40.94 |
| 5 | 23 | −120.87 |

NUMERICAL EXAMPLE 4
UNIT: mm
SURFACE DATA

| Surface No. | r | d | nd | νd |
|---|---|---|---|---|
| 1 | 164.876 | 1.50 | 1.48749 | 70.2 |
| 2 | 20.639 | 14.62 | | |
| 3 | −28.988 | 1.20 | 1.51633 | 64.1 |
| 4 | 56.721 | 1.71 | | |
| 5 | 67.034 | 12.02 | 1.76385 | 48.5 |
| 6 | −22.034 | 1.30 | 1.85478 | 24.8 |
| 7 | −60.124 | 0.20 | | |
| 8 | 255.835 | 3.91 | 2.00069 | 25.5 |
| 9 | −65.496 | (Variable) | | |
| 10 | 55.934 | 2.55 | 1.48749 | 70.2 |
| 11 | 118.796 | (Variable) | | |
| 12 | ∞ | 2.50 | | |
| (SP) | | | | |
| 13 | 245.321 | 5.61 | 1.80400 | 46.5 |
| 14 | −26.450 | 1.10 | 1.65412 | 39.7 |
| 15 | 93.220 | (Variable) | | |
| 16 | −32.006 | 4.68 | 1.43875 | 94.7 |
| 17 | −15.087 | 1.00 | 1.77047 | 29.7 |
| 18 | −395.455 | 0.20 | | |
| 19 | 54.595 | 8.22 | 1.49700 | 81.5 |
| 20 | −29.862 | 0.20 | | |
| 21* | 85.004 | 7.97 | 1.80400 | 46.5 |
| 22* | −35.187 | (Variable) | | |
| 23 | 243.427 | 3.53 | 1.92286 | 20.9 |
| 24 | −89.105 | 1.30 | 1.72047 | 34.7 |
| 25 | 45.357 | 4.55 | | |
| 26 | −95.961 | 1.30 | 1.61340 | 44.3 |
| 27 | −500.012 | 15.75 | | |
| Image Plane | ∞ | | | |

ASPHERIC DATA

21st Surface
K = 0.00000e+00 A 4 = −1.03176e−05 A 6 = −8.97599e−12
A 8 = 4.79996e−12 A10 = 8.77999e−15 A12 = 2.29248e−16
22nd Surface
K = 0.00000e+00 A 4 = 5.65602e−06 A 6 = −6.48337e−09
A 8 = 4.74058e−11 A10 = −1.47303e−13 A12 = 5.00730e−16

VARIOUS DATA

| | |
|---|---|
| Zoom Ratio | 1.00 |
| Focal Length | 24.73 |
| Fno | 1.46 |
| Half Angle of View (°) | 36.99 |
| Image Height | 18.62 |
| Overall Lens Length | 118.38 |
| SK | 15.75 |

| | | Closest Distance |
|---|---|---|
| | Infinity | (−240 mm) |
| d9 | 6.52 | 1.50 |
| d11 | 4.58 | 9.60 |
| d15 | 8.03 | 5.45 |
| d22 | 2.34 | 4.93 |

LENS UNIT DATA

| Lens Unit | Starting Surface | Focal Length |
|---|---|---|
| 1 | 1 | 85.00 |
| 2 | 10 | 213.99 |
| 3 | 13 | 504.48 |
| 4 | 16 | 29.70 |
| 5 | 23 | −66.79 |

NUMERICAL EXAMPLE 5
UNIT: mm
SURFACE DATA

| Surface No. | r | d | nd | νd |
|---|---|---|---|---|
| 1 | 43.783 | 1.60 | 1.58313 | 59.4 |
| 2* | 23.417 | 16.54 | | |
| 3 | −28.984 | 1.33 | 1.54814 | 45.8 |
| 4 | 277.240 | 0.50 | | |
| 5 | 88.645 | 14.24 | 1.72916 | 54.7 |
| 6 | −19.731 | 1.35 | 1.85478 | 24.8 |
| 7 | −57.127 | 8.76 | | |
| 8 | 201.679 | 5.77 | 2.00100 | 29.1 |
| 9 | −66.138 | (Variable) | | |
| 10 | 40.947 | 4.17 | 2.00100 | 29.1 |
| 11 | 101.679 | (Variable) | | |
| 12 | 57.991 | 1.20 | 1.72047 | 34.7 |
| 13 | 34.883 | 4.90 | | |
| 14 | ∞ | (Variable) | | |
| (SP) | | | | |
| 15 | −34.531 | 3.36 | 1.59522 | 67.7 |
| 16 | −20.039 | 4.08 | 1.85478 | 24.8 |
| 17 | ∞ | 0.74 | | |
| 18 | 171.981 | 9.31 | 1.59522 | 67.7 |
| 19 | −29.525 | 0.20 | | |
| 20* | 74.578 | 5.30 | 1.80400 | 46.5 |
| 21* | −99.853 | (Variable) | | |
| 22 | 425.998 | 2.27 | 1.92286 | 20.9 |
| 23 | −166.628 | 1.10 | 1.85478 | 24.8 |
| 24 | 85.417 | 4.77 | | |
| 25 | −55.961 | 1.10 | 1.92286 | 20.9 |
| 26 | −157.301 | 12.58 | | |
| Image Plane | ∞ | | | |

ASPHERIC DATA

2nd Surface
K = 0.00000e+00 A 4 = 3.77732e−07 A 6 = 1.20912e−09
A 8 = 9.37569e−12 A10 = −3.59485e−14
20th Surface
K = 0.00000e+00 A 4 = −4.40418e−06 A 6 = 9.56337e−09
A 8 = 3.90336e−12 A10 = −5.63870e−14
21st Surface
K = 0.00000e+00 A 4 = 2.05459e−06 A 6 = 1.29956e−08
A 8 = 1.86436e−12 A10 = −4.98030e−14

VARIOUS DATA

| | |
|---|---|
| Zoom Ratio | 1.00 |
| Focal Length | 33.95 |
| Fno | 1.46 |
| Half Angle of View (°) | 32.51 |
| Image Height | 21.64 |
| Overall Lens Length | 120.42 |
| SK | 12.58 |

| | | Closest Distance |
|---|---|---|
| | Infinity | (−280 mm) |
| d9 | 3.89 | 1.51 |
| d11 | 1.25 | 3.63 |
| d14 | 9.10 | 5.07 |
| d21 | 1.00 | 5.03 |

LENS UNIT DATA

| Lens Unit | Starting Surface | Focal Length |
|---|---|---|
| 1 | 1 | 53.39 |
| 2 | 10 | 66.21 |
| 3 | 12 | −124.21 |
| 4 | 15 | 43.59 |
| 5 | 22 | −54.75 |

NUMERICAL EXAMPLE 6
UNIT: mm
SURFACE DATA

| Surface No. | r | d | nd | νd |
|---|---|---|---|---|
| 1 | 47.083 | 3.56 | 1.58313 | 59.4 |
| 2* | 23.045 | 15.68 | | |
| 3 | −29.822 | 1.30 | 1.54814 | 45.8 |
| 4 | 226.204 | 0.50 | | |
| 5 | 95.025 | 12.77 | 1.72916 | 54.7 |
| 6 | −19.972 | 1.37 | 1.85478 | 24.8 |
| 7 | −56.259 | 7.76 | | |
| 8 | 242.497 | 5.57 | 2.00100 | 29.1 |
| 9 | −62.507 | (Variable) | | |
| 10 | 42.047 | 4.03 | 2.00100 | 29.1 |
| 11 | 100.490 | (Variable) | | |
| 12 | ∞ | 1.00 | | |
| (SP) | | | | |
| 13 | 63.310 | 1.20 | 1.72047 | 34.7 |
| 14 | 34.670 | (Variable) | | |
| 15 | −36.545 | 4.66 | 1.59522 | 67.7 |
| 16 | −19.259 | 2.60 | 1.85478 | 24.8 |
| 17 | −790.838 | 0.38 | | |
| 18 | 132.302 | 8.74 | 1.59522 | 67.7 |
| 19 | −30.308 | 0.77 | | |
| 20* | 93.567 | 5.00 | 1.80400 | 46.5 |
| 21* | −94.997 | (Variable) | | |
| 22 | 225.255 | 4.62 | 1.92286 | 20.9 |
| 23 | −61.380 | 1.10 | 1.85478 | 24.8 |
| 24 | 99.679 | 4.76 | | |
| 25 | −52.341 | 1.10 | 1.92286 | 20.9 |
| 26 | −151.590 | 12.00 | | |
| Image Plane | ∞ | | | |

ASPHERIC DATA

2nd Surface
K = 0.00000e+00 A 4 = 6.10647e−07 A 6 = 3.41983e−09
A 8 = −2.22684e−12 A10 = 1.16645e−14
20th Surface
K = 0.00000e+00 A 4 = −4.62032e−06 A 6 = 9.91179e−09
A 8 = 1.34288e−12 A10 = −1.34773e−14
21st Surface
K = 0.00000e+00 A 4 = 1.21538e−06 A 6 = 1.12263e−08
A 8 = 7.22485e−12 A10 = −1.40251e−14

VARIOUS DATA

| | |
|---|---|
| Zoom Ratio | 1.00 |
| Focal Length | 34.00 |
| Fno | 1.46 |
| Half Angle of View (°) | 32.47 |
| Image Height | 21.64 |
| Overall Lens Length | 120.33 |
| SK | 12.00 |

| | | Closest Distance |
|---|---|---|
| | Infinity | (−280 mm) |
| d9 | 3.46 | 1.45 |
| d11 | 2.53 | 4.54 |
| d14 | 12.87 | 7.59 |
| d21 | 1.00 | 6.27 |

LENS UNIT DATA

| Lens Unit | Starting Surface | Focal Length |
|---|---|---|
| 1 | 1 | 57.81 |
| 2 | 10 | 69.82 |
| 3 | 13 | −108.28 |
| 4 | 15 | 48.13 |
| 5 | 22 | −67.70 |

NUMERICAL EXAMPLE 7
UNIT: mm
SURFACE DATA

| Surface No. | r | d | nd | νd |
|---|---|---|---|---|
| 1 | −3772.354 | 1.70 | 1.61340 | 44.3 |
| 2 | 89.552 | 5.10 | | |
| 3 | −150.035 | 1.60 | 1.72047 | 34.7 |
| 4 | 99.100 | 4.35 | | |
| 5 | −171.769 | 5.82 | 1.90043 | 37.4 |
| 6 | −46.321 | 1.70 | 1.85478 | 24.8 |
| 7 | −82.039 | 0.15 | | |
| 8 | 49.323 | 6.73 | 1.95375 | 32.3 |
| 9 | 9674.983 | (Variable) | | |
| 10 | 40.209 | 3.76 | 1.87070 | 40.7 |
| 11 | 66.253 | (Variable) | | |
| 12 | 47.413 | 7.03 | 1.53775 | 74.7 |
| 13 | −75.535 | 1.40 | 1.73037 | 32.2 |
| 14 | 28.494 | 6.06 | | |
| 15 | ∞ | (Variable) | | |
| (SP) | | | | |
| 16 | −28.889 | 1.91 | 1.59522 | 67.7 |
| 17 | −22.457 | 1.00 | 1.77047 | 29.7 |
| 18 | 481.120 | 0.15 | | |
| 19 | 236.240 | 4.49 | 1.59522 | 67.7 |
| 20 | −34.012 | 2.54 | | |
| 21* | 194.734 | 6.00 | 1.80400 | 46.5 |
| 22* | −62.341 | (Variable) | | |
| 23 | 75.902 | 11.02 | 2.00100 | 29.1 |
| 24 | −39.425 | 2.00 | 1.69895 | 30.1 |
| 25 | 47.404 | 8.39 | | |
| 26 | −41.904 | 1.92 | 1.92286 | 20.9 |
| 27 | −43.198 | 12.50 | | |
| Image Plane | ∞ | | | |

ASPHERIC DATA

21st Surface
K = 0.00000e+00 A 4 = −2.27641e−06 A 6 = 1.71078e−08
A 8 = −5.41955e−11 A10 = 1.42428e−13 A12 = −5.81246e−17
22nd Surface
K = 0.00000e+00 A 4 = 2.77125e−06 A 6 = 5.91417e−09
A 8 = 1.65337e−11 A10 = −5.38391e−14 A12 = 1.64656e−16

VARIOUS DATA

| | |
|---|---|
| Zoom Ratio | 1.00 |
| Focal Length | 49.35 |
| Fno | 1.46 |
| Half Angle of View (°) | 23.67 |
| Image Height | 21.64 |
| Overall Lens Length | 118.24 |
| BF | 12.50 |

| | Infinity |
|---|---|
| d9 | 5.79 |
| d11 | 1.25 |
| d15 | 11.88 |
| d22 | 2.00 |

LENS UNIT DATA

| Lens Unit | Starting Surface | Focal Length |
|---|---|---|
| 1 | 1 | 81.60 |
| 2 | 10 | 110.08 |
| 3 | 12 | −65.81 |
| 4 | 16 | 85.99 |
| 5 | 23 | 150.11 |

TABLE 1

| | | NUMERICAL EXAMPLE | | | | | | |
|---|---|---|---|---|---|---|---|---|
| | | 1 | 2 | 3 | 4 | 5 | 6 | 7 |
| (1) | f1/f | 1.093 | 1.145 | 1.217 | 3.437 | 1.573 | 1.7 | 1.654 |
| (2) | GFf/GRf | 1.701 | 1.588 | 1.268 | 1.037 | 0.08 | 0.048 | 1.832 |
| (3) | SK/f | 0.302 | 0.273 | 0.271 | 0.637 | 0.371 | 0.353 | 0.253 |
| (4) | T1/f | 0.742 | 0.77 | 0.622 | 1.475 | 1.475 | 1.427 | 0.550 |
| (5) | T2/f | 0.063 | 0.061 | 0.064 | 0.103 | 0.123 | 0.118 | 0.076 |
| (6) | T3/f | 0.025 | 0.025 | 0.15 | 0.271 | 0.035 | 0.035 | 0.171 |
| (7) | T4/f | 0.415 | 0.424 | 0.438 | 0.901 | 0.677 | 0.651 | 0.326 |
| (8) | T5/f | 0.339 | 0.36 | 0.385 | 0.432 | 0.272 | 0.341 | 0.473 |
| (9) | f2/f | 2.571 | 2.646 | 2.795 | 8.654 | 1.95 | 2.054 | 2.231 |
| (10) | f4/f | 0.785 | 0.81 | 0.844 | 1.201 | 1.284 | 1.416 | 1.742 |
| (11) | \|f5/f\| | 1.988 | 2.18 | 2.492 | 2.701 | 1.612 | 1.991 | 3.042 |
| (12) | f2/f4 | 3.277 | 3.269 | 3.311 | 7.206 | 1.519 | 1.451 | 1.280 |
| (13) | f1/f2 | 0.425 | 0.433 | 0.436 | 0.397 | 0.806 | 0.828 | 0.741 |
| (14) | f12/f | 0.745 | 0.781 | 0.805 | 2.049 | 0.702 | 0.749 | 0.516 |
| (15) | GFf/f | 1.984 | 1.873 | 1.592 | 2.049 | 0.928 | 0.749 | 1.896 |

### Image Pickup Apparatus

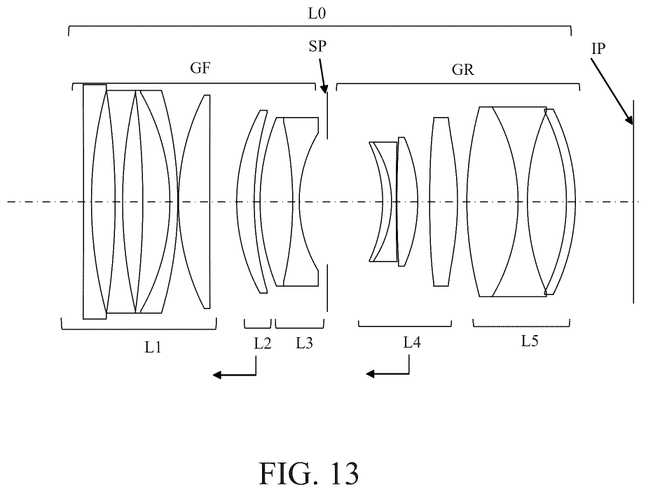

FIG. 13 illustrates a digital still camera (image pickup apparatus) that uses the optical system L0 according to any one of Examples 1 to 7 as an imaging optical system.

Reference numeral 10 denotes a camera body, and reference numeral 11 denotes the imaging optical system that includes any one of the optical systems L0 according to Examples 1 to 7. Reference numerals 12 denotes a solid-state image sensor (photoelectric conversion element) such as a CCD sensor or CMOS sensor that is built into the camera body 10 and captures (photoelectrically converts) an optical image formed by the imaging optical system 11, i.e., images an object through the imaging optical system 11.

The camera body 10 may be a single-lens reflex camera with a quick-turn mirror, or a mirrorless camera without a quick-turn mirror.

Applying the optical systems according to Examples 1 to 7 to an image pickup apparatus such as a digital still camera can achieve an image pickup apparatus that has a wide angle of view, a large aperture ratio, a reduced size, and high optical performance, and high-speed AF ability.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical system that has a reduced size and weight, a large aperture ratio, high-speed focusing ability, and various well-corrected aberrations.

This application claims priority to Japanese Patent Application No. 2024-027205, which was filed on Feb. 27, 2024, and which is hereby incorporated by reference herein in its entirety.

What is claimed is:

1. An optical system comprising, in order from an object side to an image side:
a first lens unit with positive refractive power;
a second lens unit with positive refractive power;
a third lens unit;
a fourth lens unit with positive refractive power; and
a fifth lens unit,
wherein a distance between adjacent lens units changes during focusing,
wherein the optical system further comprises an aperture stop disposed between the second lens unit and the third lens unit or between the third lens unit and the fourth lens unit,
wherein for focusing, each of the first lens unit, the third lens unit, and the fifth lens unit does not move, and each of the second lens unit and the fourth lens unit moves, and
wherein the following inequalities are satisfied:
$$0.2 \leq f 1 / f \leq 3.6 \\ - 0.05 \leq GFf / GRf \leq 10. \\ 0.2 \leq T 5 / f \leq 0.9$$
where f1 is a focal length of the first lens unit, f is a focal length of the optical system in an in-focus state on an object at infinity, GFf is a combined focal length of all lens units on the object side of the aperture stop in the in-focus state on the object at infinity, GRf is a combined focal length of all lens units on the image side of the aperture stop in the in-focus state on the object at infinity, and T5 is a distance on an optical axis from a lens surface closest to the object of the fifth lens unit to a lens surface closest to an image plane of the fifth lens unit.

2. The optical system according to claim 1, wherein the following inequality is satisfied:
$$0.1 \leq SK / f \leq 0.7$$
where SK is an air equivalent distance on the optical axis from a lens surface closest to the image plane of the optical system to the image plane.

3. The optical system according to claim 1, wherein the following inequality is satisfied:
$$0.2 \leq T 1 / f \leq 3.$$
where T1 is a distance on the optical axis from a lens surface closest to the object of the first lens unit to a lens surface closest to the image plane of the first lens unit.

4. The optical system according to claim 1, wherein the following inequality is satisfied:
$$0.01 \leq T 2 / f \leq 0.3$$
where T2 is a distance on the optical axis from a lens surface closest to the object of the second lens unit to a lens surface closest to the image plane of the second lens unit.

5. The optical system according to claim 1, wherein the following inequality is satisfied:
$$0.01 \leq T 3 / f \leq 0.5$$
where T3 is a distance on the optical axis from a lens surface closest to the object of the third lens unit to a lens surface closest to the image plane of the third lens unit.

6. The optical system according to claim 1, wherein the following inequality is satisfied:
$$0.1 \leq T 4 / f \leq 1.5$$
where T4 is a distance on the optical axis from a lens surface closest to the object of the fourth lens unit to a lens surface closest to the image plane of the fourth lens unit.

7. The optical system according to claim 1, wherein the following inequality is satisfied:
$$0.5 \leq f 2 / f \leq 9.$$
where f2 is a focal length of the second lens unit.

8. The optical system according to claim 1, wherein the following inequality is satisfied:
$$0.1 \leq f 4 / f \leq 4.$$
where f4 is a focal length of the fourth lens unit.

9. The optical system according to claim 1, wherein the following inequality is satisfied:
$$0.2 \leq \vert f 5 / f \vert \leq 7.$$
where f5 is a focal length of the fifth lens unit.

10. The optical system according to claim 1, wherein the following inequality is satisfied:
$$0.5 \leq f 2 / f 4 \leq 7.5$$
where f2 is a focal length of the second lens unit, and f4 is a focal length of the fourth lens unit.

11. The optical system according to claim 1, wherein the following inequality is satisfied:
$$0.1 \leq f 1 / f 2 \leq 5.$$
where f2 is a focal length of the second lens unit.

12. The optical system according to claim 1, wherein the following inequality is satisfied:
$$0.1 \leq f 12 / f \leq 5.$$
where f12 is a combined focal length of the first lens unit and the second lens unit in the in-focus state on the object at infinity.

13. The optical system according to claim 1, wherein the following inequality is satisfied:
$$0.1 \leq GFf / f \leq 5. .$$

14. The optical system according to claim 1, wherein the second lens unit includes a single lens element.

15. The optical system according to claim 1, wherein the third lens unit includes a single lens element.

16. The optical system according to claim 1, wherein the first lens unit includes two negative lenses.

17. The optical system according to claim 1, comprising, in order from the object side to the image side:
the first lens unit;
the second lens unit;
the third lens unit with negative refractive power;
the aperture stop;
the fourth lens unit; and
the fifth lens unit with negative refractive power.

18. The optical system according to claim 1, further comprising, in order from the object side to the image side:
the first lens unit;
the second lens unit;
the aperture stop;
the third lens unit with positive refractive power;
the fourth lens unit; and
the fifth lens unit with negative refractive power.

19. The optical system according to claim 1, comprising, in order from the object side to the image side:
the first lens unit;
the second lens unit;
the aperture stop;
the third lens unit with negative refractive power;
the fourth lens unit; and
the fifth lens unit with negative refractive power.

20. The optical system according to claim 1, comprising, in order from the object side to the image side:
the first lens unit;
the second lens unit;
the third lens unit with negative refractive power;
the aperture stop;
the fourth lens unit; and
the fifth lens unit with positive refractive power.

21. An image pickup apparatus comprising:
an optical system; and
an image sensor configured to image an object through the optical system,
wherein the optical system includes, in order from an object side to an image side:
a first lens unit with positive refractive power;
a second lens unit with positive refractive power;
a third lens unit;
a fourth lens unit with positive refractive power; and
a fifth lens unit,
wherein a distance between adjacent lens units changes during focusing,
wherein the optical system further comprises an aperture stop disposed between the second lens unit and the third lens unit or between the third lens unit and the fourth lens unit,
wherein for focusing, each of the first lens unit, the third lens unit, and the fifth lens unit does not move, and each of the second lens unit and the fourth lens unit moves, and
wherein the following inequalities are satisfied:
$$0.2 \leq f 1 / f \leq 3.6 \\ - 0.05 \leq GFf / GRf \leq 10. \\ 0.2 \leq T 5 / f \leq 0.9$$
where f1 is a focal length of the first lens unit, f is a focal length of the optical system in an in-focus state on the object at infinity, GFf is a combined focal length of all lens units on the object side of the aperture stop in the in-focus state on the object at infinity, GRf is a combined focal length of all lens units on the image side of the aperture stop in the in-focus state on the object at infinity, and T5 is a distance on an optical axis from a lens surface closest to the object of the fifth lens unit to a lens surface closest to an image plane of the fifth lens unit.
